(19) United States
(12) Patent Application Publication
(10) Pub. No.: US 2008/0013623 A1
(43) Pub. Date: Jan. 17, 2008

(54) SCALABLE VIDEO CODING AND DECODING

(75) Inventors: Xianglin Wang, Santa Clara, CA (US); Justin Ridge, Sachse, TX (US)

Correspondence Address: FOLEY & LARDNER LLP, P.O. BOX 80278, SAN DIEGO, CA, 92138-0278, US

(73) Assignee: Nokia Corporation

(21) Appl. No.: 11/777,556

(22) Filed: Jul. 13, 2007

Related U.S. Application Data
(60) Provisional application No. 60/831,364, filed on Jul. 17, 2006.

(51) Int. Cl. H04B 1/66; H04N 11/04; H04N 7/12

(52) U.S. Cl. 375/240.1; 375/240.24; 375/240.26

(57) ABSTRACT

An improved system and method for effectively reducing prediction drift and improving coding efficiency in scalable video coding. The present invention provides an improved method for determining an offset value that is used to adjust the value of α, a leaky factor for a block of data that includes only zero coefficients at a base layer. In one embodiment of the invention, the offset value is determined based upon information in the enhancement layer at issue instead of the base layer. In another embodiment, information in both the enhancement layer and the base layer of the current frame is used in determining the offset value.

### CROSS-REFERENCE TO RELATED APPLICATIONS

The present application claims priority to U.S. Povisional Patent Application No. 60/831,364, filed Jul. 17, 2006.

### FIELD OF THE INVENTION

The present invention relates generally to video coding and video decoding. More particularly, the present invention relates to scalable video coding and decoding.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC). In addition, there are currently efforts underway with regard to the development of new video coding standards. One such standard under development is the scalable video coding (SVC) standard, which will become the scalable extension to the H.264/AVC standard.

A signal-to-noise ratio (SNR) scalable video stream has the property that the video of a lower quality level can be reconstructed from a partial bitstream. Fine granularity scalability (FGS) is one type of SNR scalability that the scalable stream can be arbitrarily truncated. FIG. 1 illustrates how a stream of FGS property is generated in MPEG-4. First, a base layer is coded in a non-scalable bitstream. An FGS layer is then coded on top of that. The arrows in FIG. 1 indicate the prediction relationship, i.e., the base layer of Frame n-1 is used to predict both the base layer of Frame n and the first FGS layer of Frame n-1, etc. MPEG-4 FGS does not exploit any temporal correlation within the FGS layers. As a result, MPEG-4 FGS has the maximal bitstream flexibility, since truncation of the FGS stream of one frame will not affect the decoding of other frames. However, this arrangement hinders overall coding performance.

It is desirable to introduce temporal prediction loop in the FGS layer coding in order to improve coding efficiency, as shown in FIG. 2. However, since the FGS layer of any frame can be partially decoded, the error caused by the difference between the reference frames used in the decoder and encoder will accumulate over time, resulting in drift. Such drift can cause significant degradation to coding performance in the case of partial decoding of FGS frames.

Leaky prediction is a technique that has been used to seek a balance between coding performance and drift control in SNR enhancement layer coding. Leaky prediction is discussed in detail in Hsiang-Chun Huang; Chung-Neng Wang; Tihao Chiang, “A robust fine granularity scalability using trellis-based predictive leak”, IEEE Transactions on Circuits and Systems for Video Technology, pages 372-385, vol. 12, Issue 6, June 2002, incorporated herein by reference in its entirety. To encode the FGS layer of a n-th frame, the actual reference frame is formed with a linear combination of the base layer reconstructed frame and the enhancement layer reference frame. If an enhancement layer reference frame is partially reconstructed in the decoder, the leaky prediction method limits the propagation of the error caused by the mismatch between the reference frame used by the encoder and that used by the decoder. This is because the error will be attenuated every time a new reference signal is formed.

In U.S. Provisional Patent Application No. 60/671,263, filed on Apr. 13, 2005 and incorporated herein by reference in its entirety, a method is described that chooses leaky factors adaptively based on the information coded in the based layer. With such a method, the temporal prediction is efficiently incorporated in FGS layer coding to boost the coding performance and, at the same time, the drift can be effectively controlled. In another system, U.S. Provisional Patent Application No. 60/724,521, filed Oct. 6, 2005 and incorporated herein by reference in its entirety, which is based on the method proposed in U.S. Provisional Patent Application No. 60/671,263, further simplifications and improvements are added. These various methods are also described in U.S. Patent Application No. 11/403,233, filed Apr. 12, 2006 and also incorporated herein by reference in its entirety.

As in typical predictive coding in a non-scalable single layer video codec, to code a block of size M×N, Xⁿ in the FGS layer, a reference block Rₐ ⁿ is used. As discussed in U.S. Provisional Patent Application No. 60/671,263, Rₐⁿ is formed adaptively from a reference block X_{b}ⁿ , which is in the base layer reconstructed frame but collocated with the current block to be coded, and a reference block Rₑ ⁿ⁻¹ from the enhancement layer reference frame based on the coefficients coded in the base layer, Qₙ^{b.}The forming of Rₐⁿ is based on the following: If Q_{b}ⁿ =0, i.e., all coefficients Q_{b}ⁿ (u, v), 0<u<M,0≦v<N are zero, the reference block Rₐⁿ is calculated as the weighted average of X_{b}ⁿ and Rₑ^{n-1,}
Rₐⁿ =α·X_{b}ⁿ+(1−α)·Rₑⁿ⁻¹ if Q_{b}ⁿ=0

Otherwise, a transform is performed on X_{b}ⁿand Rₑⁿ⁻¹ to obtain the transform coefficients F_{X}_{_{b}}ⁿ=ƒ(X_{b}ⁿ), F_{R}_{ₑ}ⁿ⁻¹=ƒ(Rₑⁿ⁻¹) respectively. A coefficient block F_{R}_{ₐ}ⁿ(u,v), 0≦u<M, 0≦v<N is formed based on the base layer coefficient value.
F_{R}_{ₐ}ⁿ(u,v)=β·F_{X}_{_{b}}ⁿ(u,v)+(1−β)·F_{R}_{ₑ}ⁿ⁻¹(u,v)
if Q_{b}ⁿ(u,v)=0 F_{R}_{ₐ}ⁿ(u,v)=F_{X}_{_{b}}ⁿ(u,v) if Q_{b}ⁿ(u,v)≠0

The actual reference block is obtained by performing an inverse transform on F_{R}_{ₐ}ⁿ
Rₐⁿ=g(F_{R}_{ₐ}ⁿ)

All leaky factors, also referred as weighting factors, are assumed to be normalized so that they are in the range of [0, 1]. α is the leaky factor for a block that includes only zero coefficients at the base layer. β is the leaky factor for zero coefficients in a block that contains non-zero coefficient at the base layer. According to the current draft of Annex F of H.264/AVC, the values of α and β are first specified in the header of each progressive refinement slice (i.e., FGS slice). These values are then adaptively adjusted with an offset value from the specified values. The adjusted values, which are the summation of the offset value and the value of α or β specified in the slice header, are eventually to be used in obtaining the reference block Rₐⁿ.

According to the current draft of Annex F of H.264/AVC, the offset value used for adjustment on the value of α is based on the context for coded block flag as defined in H.264 for the block X_{b}ⁿ at the base layer. Such context can be used as an indicator to indicate whether the neighboring blocks of the block X_{b}ⁿ at the base layer contain only zero value coefficients as well. In general, when X_{b}ⁿ has one or more neighboring blocks that contain only zero value coefficients as well, it is more likely for the current block Xⁿ at the enhancement layer to have many zero value coefficients. As a result, the value of α can be adjusted so that a, in this case, bigger weighting factor is given to the enhancement layer reference block Rₑⁿ⁻¹ in forming the reference block Rₐⁿ.

Recently there have been different methods proposed for determining the offset value for adjusting the value of α. In Steffen Kamp, Mathias Wien, JVT-S092, “Local adaptation of leak factor in AR-FGS”, Geneva, Switzerland, Mar. 31˜Apr. 7, 2006 and Steffen Kamp, Mathias Wien, JVT-T062, “Improved adaptation and coding of leak factor in AR-FGS,” Klagenfurt, Austria, July 2006, both of which are incorporated herein by reference in their entirety, a method was proposed that determines the offset value based on the coding mode of the macroblock at the base layer that contains the block X_{b}ⁿ. A method presented in G. H. Park, S. Jeong, M. W. Park, S. P. Shin, D. Y. Suh, A. Moon, J. W. Hong, JVT-T021, “Leaky factor overriding in skip mode for AR-FGS,” also incorporated herein by reference in its entirety, adjusts the offset value further if the macroblock at the base layer that contains the block Rₐⁿ is coded in skip mode as defined in H.264. The method described in L. Cieplinski, JVT-T078, “MV based adaptation leak factors for AR-FGS”, Klagenfurt, Austria, July 2006, also incorporated herein by reference, is also based on the ideas presented in the Steffan Kamp reference, but further adjusts the offset value based on the differential motion vector of the block X_{b}ⁿ at the base layer. A differential motion vector is the difference between the motion vector of a current block and its predictive motion vector derived from the motion vectors of the neighboring blocks of the current block.

### SUMMARY OF THE INVENTION

Various embodiments of the present invention present an improved system and method for determining the offset value that is used to adjust the value of α. The adjusted value of α is used as a weighting factor in forming a reference block Rₐⁿ for a current block Xⁿ at an enhancement layer in case its collocated block X_{b}ⁿ at the base layer does not contain any non-zero coefficients.

According to one embodiment of the present invention, the offset value is determined based on the information from the enhancement layer rather than from the base layer. The information includes at least a coded block pattern (or CBP) of the neighboring macroblocks for a current macroblock. In a second embodiment, the offset value is determined jointly based on the information from the enhancement layer and from the base layer. The information from the base layer includes at least the context for coded block flag for the block X_{b}ⁿ. The information from the enhancement layer includes at least the CBPs of the neighboring macroblocks for a current macroblock.

The present invention provides important improvements over previous systems and methods for determining offset values. In general, the same or similar quantization parameters are used for different macroblocks in a slice. As a result, information from the same slice in an FGS enhancement layer can be more reliable and effective for use in predicting the coefficients in a current block at the enhancement layer than information from the base layer. If a better estimation can be obtained on how likely the current block will contain mainly zero value coefficients, a better prediction drift control can be realized. In previous solutions, only base layer information is used in determining the offset value. Since an FGS enhancement layer generally uses a much lower QP value than that used in its base layer, the correlation between base layer coefficients and enhancement layer coefficients is relatively low. By using information from the enhancement layer, the present invention can be used to more effectively reduce prediction drift and improve coding efficiency.

The invention can be implemented directly in software using any common programming language, e.g. C/C++ or assembly language. This invention can also be implemented in hardware and used in consumer devices.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a representation showing fine granularity scalability with no temporal prediction in the FGS layer;

FIG. 2 is a representation showing fine granularity scalability with temporal prediction in the FGS layer;

FIG. 3 is a representation showing 8x8 block indexing in a macroblock according to H.264;

FIG. 4 is a representation showing 8x8 blocks whose coded block patterns are used in determining offset values for adjusting leaky factors in a current macroblock;

FIG. 5 shows a generic multimedia communications system for use with the present invention;

FIG. 6 is a perspective view of a mobile telephone that can be used in the implementation of the present invention; and

FIG. 7 is a schematic representation of the circuitry of the mobile telephone of FIG. 6.

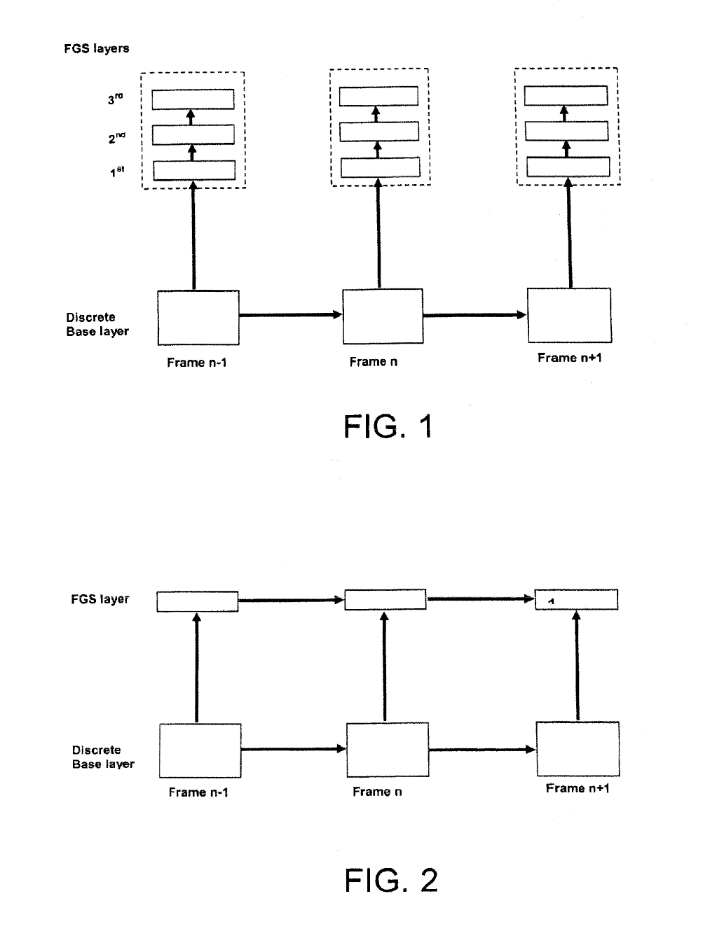

### DETAILED DESCRIPTION OF THE PREFERRED EMBODIMENTS

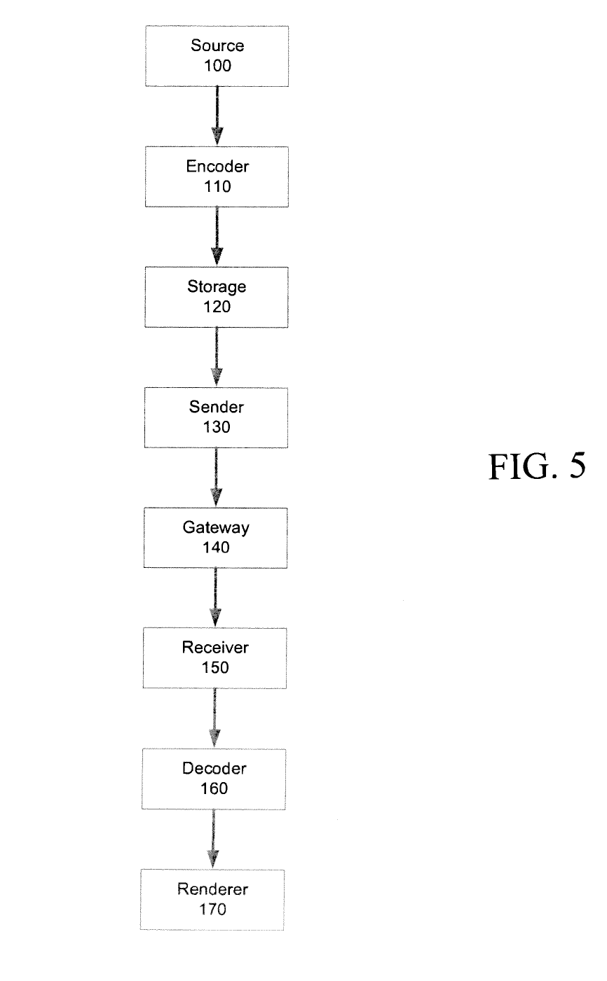

FIG. 5 shows a generic multimedia communications system for use with the present invention. As shown in FIG. 5, a data source 100 provides a source signal in an analog, uncompressed digital, or compressed digital format, or any combination of these formats. An encoder 110 encodes the source signal into a coded media bitstream. The encoder 110 may be capable of encoding more than one media type, such as audio and video, or more than one encoder 110 may be required to code different media types of the source signal. The encoder 110 may also get synthetically produced input, such as graphics and text, or it may be capable of producing coded bitstreams of synthetic media. In the following, only processing of one coded media bitstream of one media type is considered to simplify the description. It should be noted, however, that typically real-time broadcast services comprise several streams (typically at least one audio, video and text sub-titling stream). It should also be noted that the system may include many encoders, but in the following only one encoder 110 is considered to simplify the description without a lack of generality.

The coded media bitstream is transferred to a storage 120. The storage 120 may comprise any type of mass memory to store the coded media bitstream. The format of the coded media bitstream in the storage 120 may be an elementary self-contained bitstream format, or one or more coded media bitstreams may be encapsulated into a container file. Some systems operate “live”, i.e., omit storage and transfer coded media bitstream from the encoder 110 directly to the sender 130. The coded media bitstream is then transferred to the sender 130, also referred to as the server, on a need basis. The format used in the transmission may be an elementary self-contained bitstream format, a packet stream format, or one or more coded media bitstreams may be encapsulated into a container file. The encoder 110, the storage 120, and the sender 130 may reside in the same physical device or they may be included in separate devices. The encoder 110 and sender 130 may operate with live real-time content, in which case the coded media bitstream is typically not stored permanently, but rather buffered for small periods of time in the content encoder 110 and/or in the sender 130 to smooth out variations in processing delay, transfer delay, and coded media bitrate.

The sender 130 sends the coded media bitstream using a communication protocol stack. The stack may include, but is not limited to, Real-Time Transport Protocol (RTP), User Datagram Protocol (UDP), and Internet Protocol (IP). When the communication protocol stack is packet-oriented, the sender 130 encapsulates the coded media bitstream into packets. For example, when RTP is used, the sender 130 encapsulates the coded media bitstream into RTP packets according to an RTP payload format. Typically, each media type has a dedicated RTP payload format. It should again be noted that a system may contain more than one sender 130, but for the sake of simplicity, the following description only considers one sender 130.

The sender 130 may or may not be connected to a gateway 140 through a communication network. The gateway 140 may perform different types of functions, such as translation of a packet stream according to one communication protocol stack to another communication protocol stack, merging and forking of data streams, and manipulation of data streams according to the downlink and/or receiver capabilities, such as controlling the bit rate of the forwarded stream according to prevailing downlink network conditions. Examples of gateways 140 include multipoint conference control units (MCUs), gateways between circuit-switched and packet-switched video telephony, Push-to-talk over Cellular (PoC) servers, IP encapsulators in digital video broadcasting-handheld (DVB-H) systems, or set-top boxes that forward broadcast transmissions locally to home wireless networks. When RTP is used, the gateway 140 is called an RTP mixer and acts as an endpoint of an RTP connection.

Alternatively, the coded media bitstream may be transferred from the sender 130 to the receiver 150 by other means, such as storing the coded media bitstream to a portable mass memory disk or device when the disk or device is connected to the sender 130 and then connecting the disk or device to the receiver 150.

The system includes one or more receivers 150, typically capable of receiving, de-modulating, and de-capsulating the transmitted signal into a coded media bitstream. De-capsulating may include the removal of data that receivers are incapable of decoding or that is not desired to be decoded. The codec media bitstream is typically processed further by a decoder 160, whose output is one or more uncompressed media streams. Finally, a renderer 170 may reproduce the uncompressed media streams with a loudspeaker or a display, for example. The receiver 150, decoder 160, and renderer 170 may reside in the same physical device or they may be included in separate devices.

Scalability in terms of bitrate, decoding complexity, and picture size is a desirable property for heterogeneous and error prone environments. This property is desirable in order to counter limitations such as constraints on bit rate, display resolution, network throughput, and computational power in a receiving device.

Various embodiments of the present invention present an improved system and method for determining the offset value that is used to adjust the value of α. The adjusted value of α is used as a weighting factor in forming a reference block Rₐⁿ for a current block Xⁿ at an enhancement layer in case its collocated block X_{b}ⁿ at the base layer does not contain any non-zero coefficients. These various embodiments serve to more effectively reduce prediction draft and improve coding efficiency.

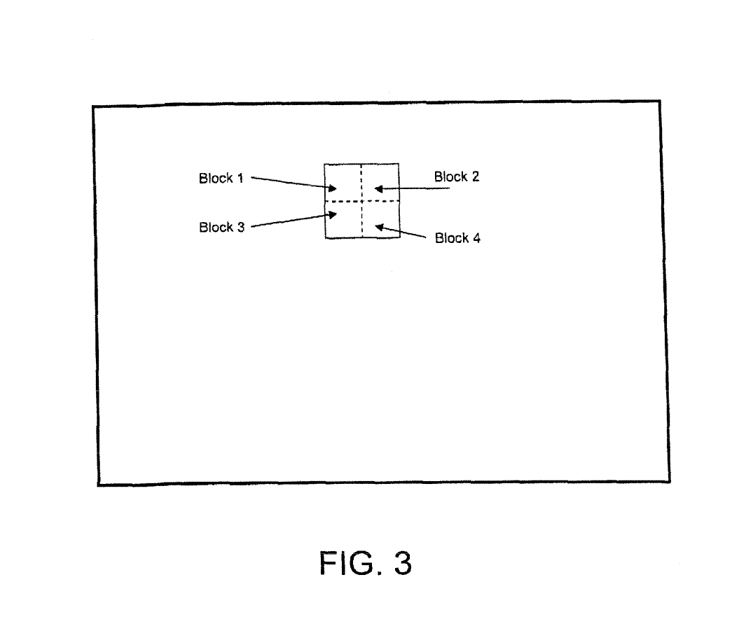

According to the current draft of Annex F of H.264/AVC, the value of α is determined as a summation of the value specified in the slide header and an offset value that is adaptively determined based on the context for the coded block flag for the block X_{b}ⁿ at the base layer. According to the various embodiments of the present invention, the offset value is determined based on information from the enhancement layer. More particularly, the CBP values of neighboring macroblocks for a current macroblock are used in determining the offset value. The CBP of a macroblock is used to indicate if the macroblock contains non-zero coefficients. According to H.264/AVC, the CBP of a macroblock includes 6 bits, of which 4 bits are used to indicate if each 8×8 block in a macroblock contains non-zero coefficients, and the other 2 bits to indicate if each of the two chroma block of the macroblock contain non-zero coefficients. FIG. 3 shows 8×8 block indexing of a macroblock in a frame. Rectangles with dashed line boundaries represent 8×8 blocks.

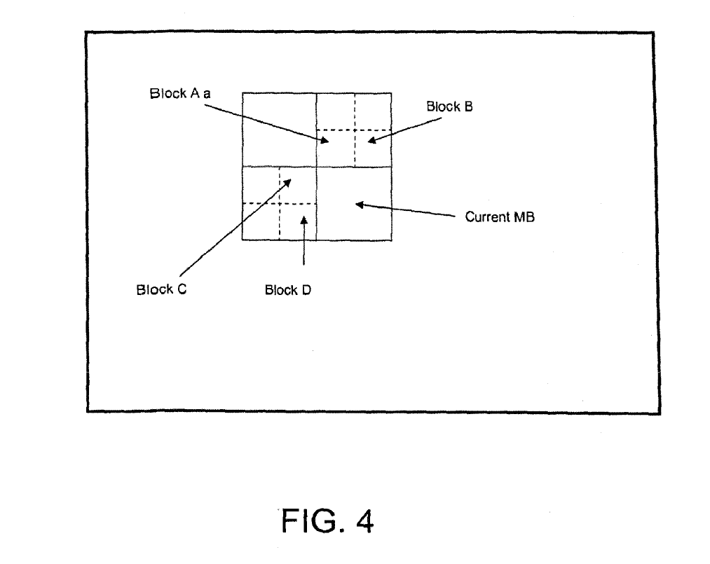

FIG. 4 shows a current macroblock and its neighboring macroblocks in a frame at an FGS enhancement layer. The CBP values of the macroblock on top of it and the block to the left of it are used. More specifically, CBP bit of blocks A, B, C and D are used in determining an offset value that is used to adjust the value of α. The offset value for each of the 8×8 blocks in the current macroblock can be different and determined separately. For each 8×8 block in the current macroblock, CBP bits used in determining an offset value are listed as follows:

1. For the first 8×8 block, CBP bit of block A and C are used.

2. For the second 8×8 block, CBP bit of block B and C are used.

3. For the third 8×8 block, CBP bit of block A and D are used.

4. For the fourth 8×8 block, CBP bit of block B and D are used.

In this case, each 8×8 block in the current macroblock has two CBP bits to use as a reference in determining an offset value for that 8×8 block. As a result, there are three possible cases—that (1) neither of the two CBP bits is zero; (2) one and only one of the two CBP bits is zero; and (3) both of the two CBP bits are zero.

Another similar but coarser method in determining neighboring block CBP conditions can also be used. In this method, for all four of 8×8 blocks in the current macroblock, a common offset value is determined and used for them. CBP values of the macroblock on top of the current macroblock and the macroblock to the left of the current macroblock are used in determining the offset value.

In this case, there are two CBP values to be used as a reference in determining an offset value for all four 8×8 blocks in the current macroblock. As a result, there are also three possible cases—that (1) neither of the two CBP values is zero; (2) one and only one of the two CBP values is zero; and (3) both of the two CBP values are zero.

Depending on the case, one of three offset values can be selected for each 8×8 block in the current macroblock. According to various embodiments of the invention and from case (1) to case (3), the offset value selected should in turn assign larger and larger weighting to enhancement layer reference blocks in forming the reference block Rₐⁿ. This is because with neighboring blocks containing only zero a value coefficients at the enhancement layer, it also becomes more likely for the current block to have many zero coefficients at the enhancement layer. As a result, it is less likely for the current block to generate prediction drift in the case of partial decoding. In this case, it is desirable to assign a relatively large weighting to the enhancement layer reference block in forming the reference block Rₐⁿ so that the prediction can be of better quality and the coding efficiency can be improved.

The following are a set of examples showing the implementation of the above embodiment in cases (1)-(3). In case (1), the offset value can be set to 0 so that the value specified in the slide header is used for α in forming the reference block Rₐⁿ. In case (2), the offset value can be set as a negative value d so that the value of α is lowered towards 0, which gives more weighting to the enhancement layer reference block in forming the reference block Rₐⁿ. For case (3), the offset value can be set as 2*d so that the value of α is lowered more towards 0. As a result, even larger weighting is given to the enhancement layer reference block in forming the reference block Rₐⁿ.

In another embodiment of the present invention, the offset value is determined based on information from both the enhancement layer and the base layer. The information from the base layer includes at least the context for coded block flag for the block X_{b}ⁿ. The information from the enhancement layer includes at least the CBPs of the neighboring macroblocks for a current macroblock.

Based on information from both the base layer and the enhancement layer, estimations can be made more accurate and reliable in terms of how likely the current block to be coded at the enhancement layer will contain many zero value coefficients. For example, if the neighboring blocks of a current block contain only zero value coefficients at both the base layer and the enhancement layer, it is more reasonable to assume that the current block will mainly contain zero value coefficients as well. In this case, the value of α can be adjusted more towards 0 so that a sufficiently large weighting is assigned to the enhancement layer reference block in forming the reference block Rₐⁿ.

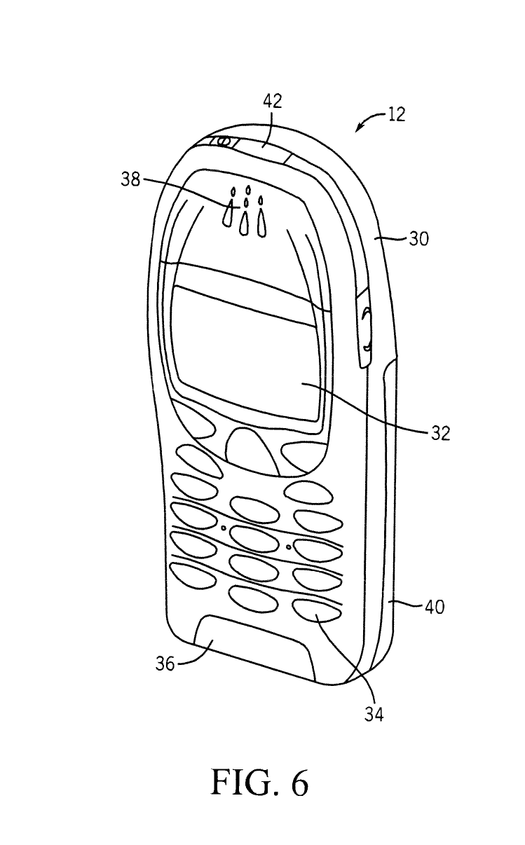

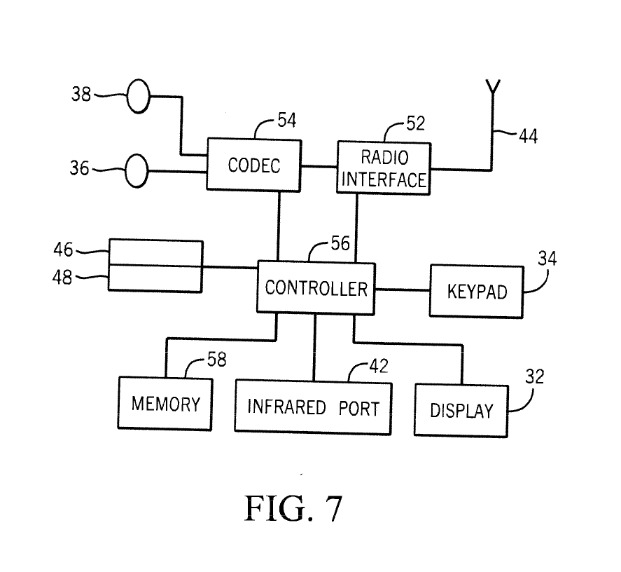

FIGS. 6 and 7 show one representative mobile telephone 12 within which the present invention may be implemented. It should be understood, however, that the present invention is not intended to be limited to one particular type of mobile telephone 12 or other electronic device.

The mobile telephone 12 of FIGS. 6 and 7 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

Communication devices of the present invention may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

1. A method of encoding fine granularity scalability (FGS) information into a bitstream, comprising:
coding a block of data in an FGS enhancement layer of a current frame using a first reference block, the first reference block formed adaptively using, if all coefficients in a base layer of the current frame are zero: a second reference block of the reconstructed base layer of the current frame, a third reference block of an FGS enhancement layer for a prior frame, a leaky factor α; and an offset value for adjusting the value of the leaky factor α,
wherein the offset value is determined based upon information from the FGS enhancement layer of the current frame.

2. The method of claim 1, wherein, for a current macroblock within which the block of data to be coded resides, coded block pattern (CBP) values of its neighboring macroblocks in the FGS enhancement layer of the current frame are used in determining the offset value.

3. The method of claim 2, wherein, for the block of data in the current macroblock, two CBP bits from neighboring macroblocks are used in determining the offset value.

4. The method of claim 3, wherein, if neither of the two CBP bits are zero, the offset value is set to zero.

5. The method of claim 3, wherein, if one and only one of the two CBP bits are zero, the offset value is set as a negative value d, lowering the adjusted value of α towards zero.

6. The method of claim 4, wherein, if both of the two CBP bits are zero, the offset value is set as a negative value 2d, lowering the adjusted value of a towards zero.

7. The method of claim 1, wherein the offset value is determined based upon information from the FGS enhancement layer of the current frame and the reconstructed base layer of the current frame.

8. The method of claim 7, wherein, for a current macroblock, coded block pattern (CBP) values of its neighboring macroblocks in the FGS enhancement layer of the current frame are used in determining the offset value.

9. The method of claim 8, wherein, for the block of data in the current macroblock, two CBP bits from neighboring macroblocks are used in determining the offset value.

10. The method of claim 7, wherein, for each block in the current macroblock, a context for a coded block flag in a corresponding block in the reconstructed base layer of the current frame is used in determining the offset value.

11. A computer program product, embodied in a computer-readable medium encoding fine granularity scalability (FGS) information into a bitstream, comprising:
computer code for coding a block of data in an FGS enhancement layer of a current frame using a first reference block, the first reference block formed adaptively using, if all coefficients in a base layer of the current frame are zero: a second reference block of the reconstructed base layer of the current frame, a third reference block of an FGS enhancement layer for a prior frame, a leaky factor α; and an offset value for adjusting the value of the leaky factor α,
wherein the offset value is determined based upon information from the FGS enhancement layer of the current frame.

12. An apparatus, comprising:
a processor; and
a memory unit communicatively connected to the processor and including computer code for coding a block of data in an FGS enhancement layer of a current frame using a first reference block, the first reference block formed adaptively using, if all coefficients in a base layer of the current frame are zero: a second reference block of the reconstructed base layer of the current frame, a third reference block of an FGS enhancement layer for a prior frame, a leaky factor α; and an offset value for adjusting the value of the leaky factor α,
wherein the offset value is determined based upon information from the FGS enhancement layer of the current frame.

13. The apparatus of claim 12, wherein, for a current macroblock within which the block of data to be coded resides, coded block pattern (CBP) values of its neighboring macroblocks in the FGS enhancement layer of the current frame are used in determining the offset value.

14. The apparatus of claim 13, wherein, for the block of data in the current macroblock, two CBP bits from neighboring macroblocks are used in determining the offset value.

15. The apparatus of claim 14, wherein, if neither of the two CBP bits are zero, the offset value is set to zero.

16. The apparatus of claim 14, wherein, if one and only one of the two CBP bits are zero, the offset value is set as a negative value 2 d, lowering the adjusted value of αt0 α towards zero.

17. The apparatus of claim 15, wherein, if both of the two CBP bits are zero, the offset value is set as a negative value 2d, lowering the adjusted value of a towards zero.

18. The apparatus of claim 12, wherein the offset value is determined based upon information from the FGS enhancement layer of the current frame and the reconstructed base layer of the current frame.

19. The apparatus of claim 18, wherein, for a current macroblock, coded block pattern (CBP) values of its neighboring macroblocks in the FGS enhancement layer of the current frame are used in determining the offset value.

20. The apparatus of claim 19, wherein, for the block of data in the current macroblock, two CBP bits from neighboring macroblocks are used in determining the offset value.

21. The apparatus of claim 18, wherein, for each block in the current macroblock, a context for a coded block flag in a corresponding block in the reconstructed base layer of the current frame is used in determining the offset value.
